(19) United States
(12) Patent Application Publication
(10) Pub. No.: US 2025/0225970 A1
(43) Pub. Date: Jul. 10, 2025

(54) SIGNAL PROCESSING METHOD AND ACOUSTIC SYSTEM

(71) Applicant: SHENZHEN SHOKZ CO., LTD., Shenzhen (CN)

(72) Inventors: Chenyang WU, Shenzhen (CN); Le XIAO, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 19/089,091

(22) Filed: Mar. 25, 2025

Related U.S. Application Data
(63) Continuation of application No. PCT/CN2023/094377, filed on May 15, 2023.

(51) Int. Cl. G10K 11/178; H04R 25/00

(52) U.S. Cl. CPC G10K 11/17819; G10K 11/17853; H04R 25/30; H04R 25/453; G10K 2210/1081; G10K 2210/3055; G10K 2210/506

(57) ABSTRACT

A signal processing method and an acoustic system are provided. When M sound sensors in a sound sensor module are in operation, they collect an ambient sound and generate M sound pickup signals. The ambient sound comprises a first sound from a speaker and a second sound from a target sound source. A signal processing circuit can perform a filtering operation on the M sound pickup signals based on M sets of target filtering parameters to obtain M filtered signals, and perform a synthesis operation on the M filtered signals to obtain a composite signal, and then perform a target operation on the composite signal. Since the M sets of target filtering parameters are configured to minimize a signal component from the speaker in the composite signal under a target constraint.

### RELATED APPLICATIONS

This application is a continuation application of PCT application No. PCT/CN2023/094377, filed on May 15, 2023, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to the field of acoustic technology, particularly to a signal processing method and an acoustic system.

### BACKGROUND

Some acoustic systems comprise both a speaker and a sound sensor. In these systems, the ambient sound collected by the sound sensor may comprise sound emitted from the speaker, which is detrimental to the operation of the acoustic system. For example, in a hearing aid system, the sound sensor collects ambient sound during operation, amplifies the gain of the ambient sound, and then plays it through the speaker to compensate for the wearer's hearing loss. When the sound emitted by the speaker is recaptured by the sound sensor, a closed-loop circuit is formed in the acoustic system, causing the sound emitted by the speaker to be continuously amplified in the loop, leading to acoustic feedback, which results in discomfort for the wearer. Additionally, in a telephone system or a conference system, voice signals from a remote user are played through the local speaker and are then collected by the local sound sensor along with the voice from the local user, and transmitted back to the remote end. As a result, the remote user may experience interference from echo.

### SUMMARY

The present disclosure provides a signal processing method and an acoustic system, capable of reducing or eliminating feedback sound in the acoustic system, thereby avoiding issues such as howling and echo in the acoustic system.

In a first aspect, the present disclosure provides an acoustic system, comprising: a speaker, configured to receives a driving signal and converts the driving signal into a first sound during operation; a sound sensor module, where the sound sensor module comprises M sound sensors and is configured to pick up an ambient sound and generate M sound pickup signals, where the ambient sound comprises the first sound and a second sound from a target sound source, and M is an integer greater than 1; and a signal processing circuit, connected to the sound sensor module, where during operation, the signal processing circuit is configured to perform: obtaining M sound pickup signals, performing a filtering operation on the M sound pickup signals based on M sets of target filtering parameters to obtain M filtered signals, and performing a synthesis operation on the M filtered signals to obtain a composite signal, where the M sets of target filtering parameters are configured to minimize a signal component corresponding to the first sound in the composite signal under a target constraint, and performing a target operation on the composite signal.

In a second aspect, the present disclosure provides a signal processing method, comprising: obtaining M sound pickup signals, where the M sound pickup signals are respectively obtained by M sound sensors in a sound sensor module of an acoustic system collecting an ambient sound during operation, the ambient sound comprises a first sound and a second sound, the first sound is a sound from a speaker in the acoustic system, and the second sound is a sound from a target sound source, where M is an integer greater than 1; performing a filtering operation on the M sound pickup signals based on M sets of target filtering parameters to obtain M filtered signals, and performing a synthesis operation on the M filtered signals to obtain a composite signal, where the M sets of target filtering parameters are configured to minimize a signal component corresponding to the first sound in the composite signal under a target constraint; and performing a target operation on the composite signal.

From the above technical solution, it can be seen that the signal processing method and acoustic system provided by this disclosure involve M sound sensors in the sound sensor module collecting ambient sound and generating M sound pickup signals when operating. The ambient sound comprises a first sound from the speaker and a second sound from the target sound source. The signal processing circuit can perform a filtering operation on the M sound pickup signals based on M sets of target filtering parameters to obtain M filtered signals, and then perform a synthesis operation on the M filtered signals to obtain a composite signal, subsequently executing a target operation on the composite signal. Since the M sets of target filtering parameters are configured to minimize the signal component from the speaker in the composite signal under a target constraint, the above filtering operation can reduce or eliminate the feedback sound in the acoustic system (i.e., the sound from the speaker), thereby preventing issues such as howling or echo in the acoustic system.

Other functions of the acoustic system provided by this disclosure and the signal processing method applied to the acoustic system will be partially listed in the following description. The inventive aspects of the acoustic system provided by this disclosure and the signal processing method applied to the acoustic system can be fully explained through practice or use of the methods, devices, and combinations described in the detailed examples below.

### BRIEF DESCRIPTION OF THE DRAWINGS

To more clearly illustrate the technical solutions in the embodiments of this disclosure, the drawings required for the description of the embodiments will be briefly introduced below. Obviously, the drawings described below are merely some exemplary embodiments of this disclosure. For a person of ordinary skill in the art, other drawings can also be obtained based on these drawings without any creative effort.

FIG. 1 shows a schematic diagram of an application scenario provided according to some exemplary embodiments of this disclosure;

FIG. 2 shows a schematic diagram of another application scenario provided according to some exemplary embodiments of this disclosure;

FIG. 3 shows a schematic design diagram of an acoustic system provided according to some exemplary embodiments of this disclosure;

FIG. 4 shows a schematic structural diagram of an acoustic system provided according to some exemplary embodiments of this disclosure;

FIG. 5 shows a schematic hardware design diagram of an acoustic system provided according to some exemplary embodiments of this disclosure;

FIG. 6 shows a flowchart of a signal processing method provided according to some exemplary embodiments of this disclosure;

FIG. 7 shows a schematic diagram of a signal processing process provided according to some exemplary embodiments of this disclosure;

FIG. 8A shows a schematic diagram of the signal processing scheme in FIG. 7 for canceling the sound from a speaker; and

FIG. 8B shows a schematic diagram of the signal processing scheme in FIG. 7 for attenuating the sound from a target sound source.

### DETAILED DESCRIPTION

The following description provides specific application scenarios and requirements of this disclosure, with the aim of enabling a person skilled in the art to make and use the content of this disclosure. For a person skilled in the art, various local modifications to the disclosed embodiments will be apparent, and the general principles defined herein may be applied to other embodiments and applications without departing from the spirit and scope of this disclosure. Therefore, this disclosure is not limited to the embodiments shown, but rather conforms to the broadest scope consistent with the claims.

The terminology used here is for the purpose of describing specific example embodiments only and is not restrictive. For instance, unless the context clearly indicates otherwise, the singular forms “a,” “an,” and “the” as used herein may also comprise the plural forms. When used in this disclosure, the terms “comprising,” “including,” and/or “containing” mean that the associated integers, steps, operations, elements, and/or components are present, but do not exclude the presence of one or more other features, integers, steps, operations, elements, components, and/or groups, or the addition of other features, integers, steps, operations, elements, components, and/or groups in the system/method.

In light of the following description, these features and other features of this disclosure, as well as the operation and function of related elements of the structure, the combination of components, and the economics of manufacturing, can be significantly improved. With reference to the drawings, all of which form a part of this disclosure. However, it should be clearly understood that the drawings are for illustration and description purposes only and are not intended to limit the scope of this disclosure. It should also be understood that the drawings are not drawn to scale.

The flowcharts used in this disclosure illustrate operations implemented by systems according to some exemplary embodiments of this disclosure. It should be clearly understood that the operations of the flowcharts may be implemented out of order. On the contrary, operations may be performed in reverse order or simultaneously. Additionally, one or more other operations may be added to the flowcharts. One or more operations may be removed from the flowcharts.

Before describing the specific embodiments of this disclosure, the application scenarios of this disclosure are introduced as follows.

FIG. 1 shows a schematic diagram of an application scenario provided according to some exemplary embodiments of this disclosure. This scenario can be a public address scenario, an assisted listening scenario, or a hearing aid scenario. As shown in FIG. 1, the application scenario 001 comprises a speaker 110-A and a sound sensor 120-A. The sound sensor 120-A collects the ambient sound during operation. In this process, if the speaker 110-A is also playing sound synchronously, the sound played by the speaker 110-A will also be captured by the sound sensor 120-A. Thus, the ambient sound collected by the sound sensor 120-A comprises both the sound from the target sound source 160 and the sound from the speaker 110-A. Subsequently, the aforementioned ambient sound is input into a gain amplifier (such as G in FIG. 1) for gain amplification, and then the amplified signal is sent to the speaker 110-A for playback. This forms a closed-loop circuit of “speaker-sound sensor-speaker” in the acoustic system. In this case, when self-oscillation occurs for sound signals at certain frequencies, a howling phenomenon will be generated. Such howling can cause discomfort to users, and when the howling becomes severe, it may even damage the acoustic equipment. Additionally, the presence of the howling also imposes limitations on the gain amplification factor of the gain amplifier 130, thereby restricting the maximum sound gain that the acoustic system 003 can achieve.

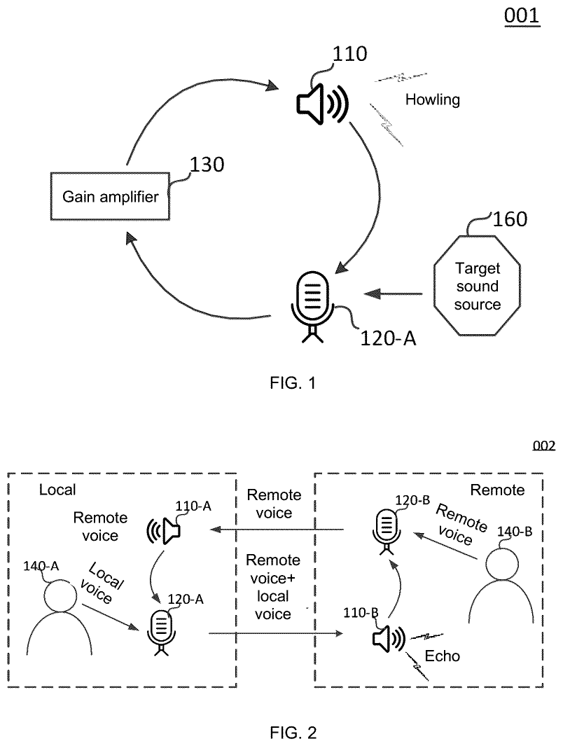

FIG. 2 shows a schematic diagram of another application scenario provided according to some exemplary embodiments of this disclosure.

This scenario can be a call scenario, such as a scenario involving communication through a telephone system, a conference system, or a voice call system. As shown in FIG. 2, the application scenario 002 comprises a local end and a remote end. The local end comprises a local user 140-A, a speaker 110-A, and a sound sensor 120-A, while the remote end comprises a remote user 140-B, a speaker 110-B, and a sound sensor 120-B. The local end and the remote end can be connected via a network. The network is a medium used to provide a communication connection between the local end and the remote end, facilitating the exchange of information or data between the two. In some exemplary embodiments, the network can be any type of wired or wireless network, or a combination thereof. For example, the network may comprise a cable network, a wired network, a fiber optic network, a telecommunications network, an intranet, the Internet, a local area network (LAN), a wide area network (WAN), a wireless local area network (WLAN), a metropolitan area network (MAN), a wide area network (WAN), a public switched telephone network (PSTN), a Bluetooth network, a ZigBee network, a near-field communication (NFC) network, or similar networks. In some exemplary embodiments, the network may comprise one or more network access points. For example, the network may comprise wired or wireless network access points, such as base stations or Internet exchange points, through which the local end and the remote end can connect to the network to exchange data or information.

Continuing with FIG. 2, during a call between the local user 140-A and the remote user 140-B, the remote voice from the remote user 140-B is collected by the sound sensor 120-B and transmitted to the local end, then played through the speaker 110-A at the local end. The remote voice played by the speaker 110-A, along with the local voice from the local user 140-A, is collected by the sound sensor 120-A at the local end, then transmitted back to the remote end and played through the speaker 110-B at the remote end. As a result, the remote user 140-B will hear own echo, thus being disturbed by this echo. It should be noted that FIG. 2 illustrates the process in which the remote user 140-B is disturbed by an echo. It should be understood that the local user 140-A may also experience echo interference, and the echo generation process at the local end is similar to that described above, which will not be elaborated herein. Such echoes can affect the normal conversation of users.

The signal processing method and acoustic system provided by some exemplary embodiments of this disclosure can be applied to scenarios requiring howling suppression (such as the scenario shown in FIG. 1) and to scenarios requiring echo cancellation (such as the scenario shown in FIG. 2). In the above scenarios, the acoustic system collects ambient sound through M sound sensors to obtain M sound pickup signals, and processes these M sound pickup signals using the signal processing method described in the embodiments of this disclosure to generate a composite signal, reducing the signal components from the speaker in the composite signal, thereby achieving the purpose of suppressing howling or eliminating echo.

It should be noted that the howling suppression scenario and echo cancellation scenario mentioned above are only some of the multiple usage scenarios provided by some exemplary embodiments of this disclosure. The signal processing method and acoustic system provided by some exemplary embodiments of this disclosure can also be applied to other similar scenarios. A person skilled in the art should understand that the application of the signal processing method and acoustic system provided by some exemplary embodiments of this disclosure to other usage scenarios also falls within the scope of the embodiments of this disclosure.

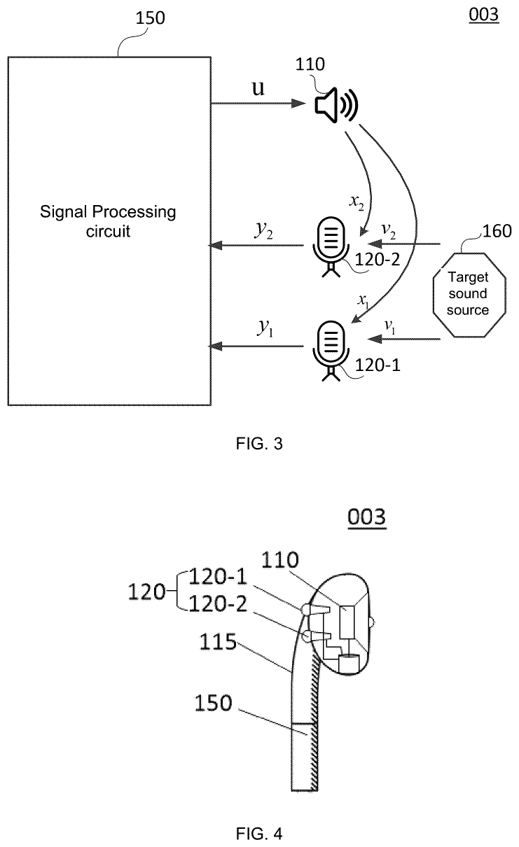

FIG. 3 shows a schematic design diagram of an acoustic system provided according to some exemplary embodiments of this disclosure. The acoustic system 003 can be a public address system, a hearing aid system, or an assisted listening system, in which case the acoustic system 003 can be applied to the application scenario shown in FIG. 1. The acoustic system 003 can also be a telephone system, a conference system, or a voice call system, in which case the acoustic system 003 can be applied to the application scenario shown in FIG. 2.

As shown in FIG. 3, the acoustic system 003 may comprise a speaker 110, a sound sensor module 120, and a signal processing circuit 150. The sound sensor module 120 may comprise M sound sensors, labeled 120-1 to 120-M, where M is an integer greater than 1. For example, in FIG. 3, M=2 is used as an example, meaning the sound sensor module 120 comprises sound sensors 120-1 and 120-2. The M sound sensors can be the same type of sound sensors or different types of sound sensors.

In the acoustic system 003, the speaker 110 and the sound sensor module 120 can be integrated into the same electronic device or can be independent of each other, and the embodiments of this disclosure do not impose any limitations on this. For example, FIG. 4 shows a schematic structural diagram of the acoustic system 003 provided according to some exemplary embodiments of this disclosure. As shown in FIG. 4, when the acoustic system 003 is a hearing aid system or an assisted listening system, the acoustic system 003 may further comprise a housing 115. In this case, the speaker 110, the sound sensor module 120, and the signal processing circuit 150 can be disposed within the housing 115. The housing 115 provides protection for the internal components and makes it convenient for users to hold and wear. The acoustic system 003 can be worn on the user's head; for example, it can be worn on the user's ear in an in-ear manner, an over-ear manner, or other methods. When the acoustic system 003 is worn on the user's head, the sound output end of the speaker 110 faces the user's head, for instance, toward the user's ear canal opening or near the ear canal opening. The sound pickup end of at least one sound sensor in the sound sensor module 120 is located on the side of the housing 115 away from the user's head. This design, on one hand, facilitates the pickup of ambient sound, and on the other hand, minimizes the pickup of sound emitted by the speaker 110 as much as possible.

In some exemplary embodiments of this disclosure, the speaker 110 is a device used to convert electrical signals into sound, also referred to as an electroacoustic transducer. For example, the speaker 110 can be a loudspeaker (speaker). Continuing with FIG. 3, the speaker 110 can be connected to the signal processing circuit 150. During operation, it receives a driving signal from the signal processing circuit 150 and converts it into sound for playback. The speaker 110 can be directly connected to the signal processing circuit 150 or connected through a first peripheral circuit (not shown in the drawings). The first peripheral circuit can perform some processing on the electrical signal output by the signal processing circuit 150, making the processed electrical signal suitable for playback by the speaker 110. The first peripheral circuit may comprise, but is not limited to, at least one of the following components: an operational amplifier, a power amplifier, a digital-to-analog converter, a filter, a tuner, a capacitor, a resistor, an inductor, or a chip.

It should be noted that the speaker 110 can be a device that emits sound based on at least one conduction medium such as gas, liquid, or solid, and this disclosure does not impose any limitations on this. The speaker 110 can be the loudspeaker itself or may comprise the loudspeaker along with its accompanying simple circuit components. The number of speakers 110 can be one or more. When there are multiple speakers 110, they can be arranged in an array form.

In some exemplary embodiments of this disclosure, the sound sensors 120-1 to 120-M are devices used to pick up sound and convert it into electrical signals, also referred to as acoustic-electric transducers. For example, the sound sensors 120-1 to 120-M can be microphones (Microphone, MIC). Continuing with FIG. 3, the sound sensors 120-1 to 120-M can be connected to the signal processing circuit 150. During operation, they pick up ambient sound to generate sound pickup signals and send the sound pickup signals to the signal processing circuit 150. The sound sensors 120-1 to 120-M can be directly connected to the signal processing circuit 150 or connected through a second peripheral circuit (not shown in the drawings). The second peripheral circuit can perform some processing on the electrical signals (i.e., sound pickup signals) picked up by the sound sensors 120-1 to 120-M, converting them into signals suitable for processing by the signal processing circuit 150. The second peripheral circuit may comprise, but is not limited to, at least one of the following components: a power amplifier, an operational amplifier, an analog-to-digital converter, a filter, a tuner, a capacitor, a resistor, an inductor, or a chip.

It should be noted that the sound sensors 120-1 to 120-M can be devices that pick up sound based on at least one conduction medium such as gas, liquid, or solid, and this disclosure does not impose any limitations on this. The sound sensors 120-1 to 120-M can be the microphone (MIC) itself or may comprise the MIC along with its accompanying simple circuit components.

Continuing with FIG. 3, the working process of the acoustic system 003 is as follows: The speaker 110 receives a driving signal u from the signal processing circuit 150 and converts it into a first sound. The target sound source 160 emits a second sound. The target sound source 160 refers to any sound source other than the speaker 110. For example, the target sound source 160 may comprise electronic devices with sound playback functions (such as a television, a speaker, a mobile phone, etc.); alternatively, the target sound source 160 may also comprise a human throat. The sound sensor 120-1 collects ambient sound to generate a sound pickup signal y₁. The ambient sound comprises the first sound from the speaker 110 and the second sound from the target sound source 160. Therefore, the sound pickup signal y₁ simultaneously comprises a signal component x₁ corresponding to the first sound and a signal component vi corresponding to the second sound. The sound sensor 120-1 sends the sound pickup signal y₁ to the signal processing circuit 150. It should be understood that the working process of the sound sensors 120-2 to 120-M is similar to that of the sound sensor 120-1, and will not be elaborated herein.

The signal processing circuit 150 can be a circuit with certain signal processing capabilities. The signal processing circuit 150 can receive sound pickup signals from the M sound sensors, meaning that the signal processing circuit 150 can receive M sound pickup signals, denoted as sound pickup signals y₁ to y_{M}. The signal processing circuit 150 can be configured to execute the signal processing method described in some exemplary embodiments of this disclosure based on the M sound pickup signals. The signal processing method will be introduced in detail in the following sections.

In some exemplary embodiments, the signal processing circuit 150 may comprise multiple hardware circuits with connection relationships, each hardware circuit comprising one or more electrical components. During operation, these circuits implement one or more steps of the signal processing method described in some exemplary embodiments of this disclosure. The multiple hardware circuits work together to realize the signal processing method described in some exemplary embodiments of this disclosure.

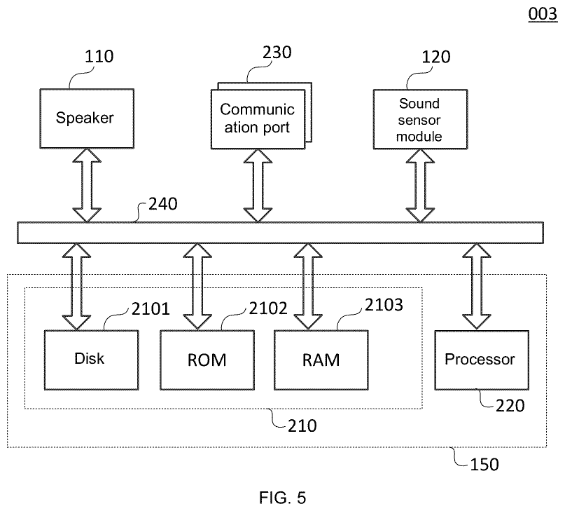

In some exemplary embodiments, the signal processing circuit 150 may comprise hardware devices with data information processing functions and the necessary programs required to drive the operation of these hardware devices. The hardware devices execute these programs to implement the signal processing method described in some exemplary embodiments of this disclosure. For example, FIG. 5 shows a schematic diagram of the hardware design of the acoustic system 003 provided according to some exemplary embodiments of this disclosure. As shown in FIG. 5, the signal processing circuit 150 may comprise at least one storage medium 210 and at least one processor 220. The at least one processor 220 is communicatively connected to the speaker 110 and the sound sensor module 120. It should be noted that, for illustrative purposes only, the signal processing circuit 150 provided in some exemplary embodiments of this disclosure comprises at least one storage medium 210 and at least one processor 220. A person of ordinary skill in the art can understand that the signal processing circuit 150 may also comprise other hardware circuit structures, which are not limited in some exemplary embodiments of this disclosure, as long as they can fulfill the functions mentioned in this disclosure without departing from the spirit of this disclosure.

Continuing with FIG. 5, in some exemplary embodiments, the acoustic system 003 may further comprise a communication port 230. The communication port 230 is used for data communication between the acoustic system and the outside world. For example, the communication port 230 can be used for data communication between the acoustic system and other devices/systems. In some exemplary embodiments, the acoustic system 003 may also comprise an internal communication bus 240. The internal communication bus 240 can connect different system components. For example, the speaker 110, the sound sensor module 120, the processor 220, the storage medium 210, and the communication port 230 can all be connected via the internal communication bus 240.

The storage medium 210 may comprise a data storage device. The data storage device can be a non-transitory storage medium or a transitory storage medium. For example, the data storage device may comprise one or more of a magnetic disk 2101, a read-only memory (ROM) 2102, or a random-access memory (RAM) 2103. The storage medium 210 also comprises at least one instruction set stored in the data storage device. The instruction set contains instructions, which are computer program code. The computer program code may comprise programs, routines, objects, components, data structures, procedures, modules, etc., for executing the signal processing method provided by some exemplary embodiments of this disclosure.

The at least one processor 220 is used to execute the aforementioned at least one instruction set. When the acoustic system 003 is running, the at least one processor 220 reads the at least one instruction set and, based on the instructions of the at least one instruction set, executes the signal processing method provided by some exemplary embodiments of this disclosure. The processor 220 can perform all or part of the steps comprised in the aforementioned signal processing method. The processor 220 can be in the form of one or more processors. In some exemplary embodiments, the processor 220 may comprise one or more hardware processors, such as a microcontroller, microprocessor, reduced instruction set computer (RISC), application-specific integrated circuit (ASIC), application-specific instruction set processor (ASIP), central processing unit (CPU), graphics processing unit (GPU), physics processing unit (PPU), microcontroller unit, digital signal processor (DSP), field-programmable gate array (FPGA), advanced RISC machine (ARM), programmable logic device (PLD), or any circuit or processor capable of performing one or more functions, or any combination thereof. For illustrative purposes only, the acoustic system 003 shown in FIG. 5 exemplifies a case with only one processor 220. However, it should be noted that the acoustic system 003 provided by some exemplary embodiments of this disclosure may also comprise multiple processors. Therefore, the operations and/or method steps disclosed in some exemplary embodiments of this disclosure may be performed by a single processor or jointly performed by multiple processors. For example, if in some exemplary embodiments of this disclosure the processor 220 of the acoustic system performs step A and step B, it should be understood that step A and step B may also be performed jointly or separately by two different processors 220 (e.g., a first processor performs step A, a second processor performs step B, or the first and second processors jointly perform steps A and B).

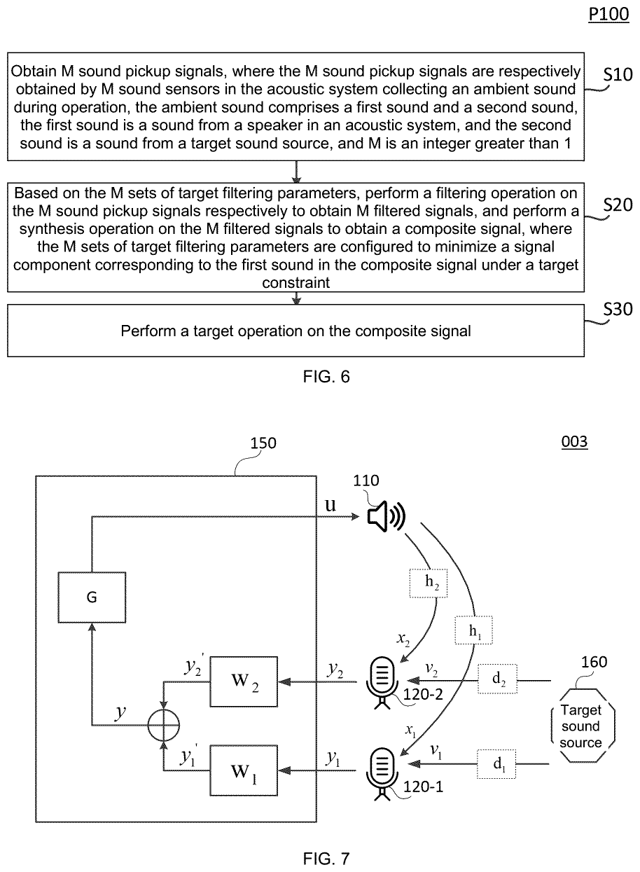

FIG. 6 shows a flowchart of a signal processing method provided according to some exemplary embodiments of this disclosure. The signal processing method P100 can be applied to the acoustic system 003 as described earlier. Specifically, the signal processing circuit 150 can execute the signal processing method P100. For example, the processor 220 in the signal processing circuit 150 can perform the signal processing method P100. As shown in FIG. 6, the signal processing method P100 may comprise:

S10: Obtain M sound pickup signals, where the M sound pickup signals are respectively obtained by M sound sensors in the acoustic system collecting an ambient sound during operation, the ambient sound comprises a first sound and a second sound, the first sound is a sound from a speaker in an acoustic system, and the second sound is a sound from a target sound source, and M is an integer greater than 1.

Herein, the signal processing circuit 150 can obtain the M sound pickup signals from the sound sensor module 120. It should be noted that the process by which the M sound sensors in the sound sensor module 120 respectively collect ambient sound and generate sound pickup signals has been described earlier and will not be repeated herein. Since the ambient sound comprises both the first sound from the speaker 110 and the second sound from the target sound source 160, each sound pickup signal contains both a signal component corresponding to the first sound (i.e., the feedback component) and a signal component corresponding to the second sound.

S20: Based on the M sets of target filtering parameters, perform a filtering operation on the M sound pickup signals respectively to obtain M filtered signals, and perform a synthesis operation on the M filtered signals to obtain a composite signal, where the M sets of target filtering parameters are configured to minimize a signal component corresponding to the first sound in the composite signal under a target constraint.

To facilitate understanding, FIG. 7 shows a schematic diagram of a signal processing process provided according to some exemplary embodiments of the present disclosure. As shown in FIG. 7, it is assumed that the M sound pickup signals obtained by the signal processing circuit 150 from the sound sensor module 120 are denoted as y₁ to y_{M}, respectively. The signal processing circuit 150 can perform a filtering operation on the M sound pickup signals based on M sets of target filtering parameters to obtain M filtered signals y₁′ to y_{M}′. Specifically, referring to FIG. 7, the signal processing circuit 150 performs a filtering operation on the sound pickup signal y₁ based on the target filtering parameter w₁ to obtain the filtered signal y₁′, i.e., y₁′=y₁*w₁. The signal processing circuit 150 performs a filtering operation on the sound pickup signal y₂ based on the target filtering parameter w₂ to obtain the filtered signal y₂′, i.e., y₂′=y₂*w₂. By analogy, the signal processing circuit 150 performs a filtering operation on the sound pickup signal y_{M} based on the target filtering parameter w_{M} to obtain the filtered signal y_{M}′, i.e., y_{M}′=y_{M}*w_{M}. Further, after the signal processing circuit 150 obtains the M filtered signals y₁′ to y_{M}′, it performs a synthesis operation on the M filtered signals y₁′ to y_{M}′ to obtain the composite signal y, i.e., y=y₁′+y₂′+ . . . +y_{M}′. For example, the above synthesis operation can be implemented through an adder. The above composite signal y can be regarded as the comprehensive pickup result of the ambient sound by the sound sensor module 120. It should be noted that FIG. 7, for illustrative convenience, only takes M=2 as an example for illustration.

The described M sets of target filtering parameter is configured to minimize the signal component (i.e., the feedback component) corresponding to the first sound in the composite signal y under a target constraint. That is to say, when the signal processing circuit 150 performs the filtering operation, it can, under certain constraints, reduce the feedback component in the composite signal y as much as possible, making the feedback component in the composite signal y minimal. In other words, the signal processing circuit 150, by performing the filtering operation, achieves beamforming for the sound sensor module 120, thereby minimizing the feedback component in the composite signal y.

For the convenience of subsequent description, the first sound emitted by the speaker 110 is denoted as x, and the second sound emitted by the target sound source 160 is denoted as v. The transfer function between the speaker 110 and the nth sound sensor is called the first transfer function and is denoted as hₙ; that is, the first transfer functions between the speaker 110 and the M sound sensors are denoted as h₁ to h_{M}, respectively. The transfer function between the target sound source 160 and the nth sound sensor is called the second transfer function and is denoted as dₙ; that is, the second transfer functions between the speaker 110 and the M sound sensors are denoted as d₁ to d_{M}, respectively. Thus, the M sound pickup signals obtained by the M sound sensors can be expressed as follows:

$${y}_{1} = x * {h}_{1} + v * {d}_{1} \qquad Formula ( 1 - 1 )$$

$${y}_{2} = x * {h}_{2} + v * {d}_{2} \qquad Formula ( 1 - 2 )$$

$$…$$

$${y}_{M} = x * {h}_{M} + v * {d}_{M} \qquad Formula ( 1 - M )$$

Furthermore, the M filtered signals can be expressed as follows:

$${y}_{1}^{′} = {y}_{1} * {w}_{1} = x * {h}_{1} * {w}_{1} + v * {d}_{1} * {w}_{1} \qquad Formula ( 1 - 1 )$$

$${y}_{2}^{′} = {y}_{2} * {w}_{2} = x * {h}_{2} * {w}_{2} + v * {d}_{2} * {w}_{2} \qquad Formula ( 2 - 2 )$$

$$…$$

$${y}_{M}^{′} = {y}_{M} * {W}_{M} = x * {h}_{M} * {W}_{M} + v * {d}_{M} * {W}_{M} \qquad Formula ( 2 - M )$$

The composite signal y can be expressed as follows:

$$y = {y}_{1}^{′} + {y}_{2}^{′} + {y}_{M}^{′} = x * {\sum }_{n = 1}^{M} ( {h}_{n} * {w}_{n} ) + v * {\sum }_{n = 1}^{M} ( {d}_{n} * {w}_{n} ) \qquad Formula ( 3 )$$

From the above formula (3), it can be seen that the composite signal y comprises two signal components, namely: the signal component corresponding to the first sound, x*Σₙ₌₁^{M}(hₙ*wₙ), and the signal component corresponding to the second sound, v*Σₙ₌₁^{M}(dₙ*wₙ). Therefore, when determining the M sets of target filtering parameters, the signal processing circuit 150 can use the following formula (4) as the optimization target, so as to minimize the signal component in the composite signal y that corresponds to the first sound.

$$min {‖ {\sum }_{n = 1}^{M} ( {h}_{n} * {w}_{n} ) ‖}_{i} \qquad Formula ( 4 )$$

Where ∥⋅∥ᵢ represents the i-norm, and the value of i can be 1, 2, or ∞.

When the values of w₁ to wₙ are all zero, the signal component in the composite signal y corresponding to the first sound becomes zero, which can satisfy the above formula (4). However, at the same time, the signal component in the composite signal y corresponding to the second sound will also become zero, which would affect the operation of the acoustic system. Therefore, in some exemplary embodiments, the target constraint may comprise: the M sets of target filtering parameters are not all zero at the same time. That is to say, the signal processing circuit 150 solves for the target filtering parameters w₁ to wₙ using the above formula (4) as the objective function, while ensuring that the M sets of target filtering parameters are not all zero simultaneously.

Based on the above target constraint, the M sets of target filtering parameters can be obtained based on the M first transfer functions (i.e., h₁ to h_{M}). For example, the M sets of target filtering parameters can be obtained in the following manner: the M sets of target filtering parameters are divided into K sets of first filter parameters and M-K sets of second filter parameters, where K is an integer greater than or equal to 1. First, the K sets of first filter parameters are set to preset non-zero values, and then the M-K sets of second filter parameters are determined based on the M first transfer functions and the K sets of first filter parameters.

The following takes M=2 as an example for illustration. The signal processing circuit 150 can first set w₁ to a preset non-zero value. For instance, assuming each set of target filtering parameters is represented by an N-dimensional vector, the value of w₁ can be set as a unit vector e (e.g., an N-dimensional vector where one element is 1 and all other elements are 0), that is:

$${w}_{1} = e \qquad Formula ( 5 )$$

Furthermore, the signal processing circuit 150 can use formula (4) as the objective function to solve for w₂. For example, the solved w₂ can be expressed as follows:

$${w}_{2} = {( {h}_{2}^{{c}^{T}} {h}_{2}^{c} )}^{- 1} {h}_{2}^{{c}^{T}} {h}_{1}^{c} e \qquad Formula ( 6 )$$

Where h₂^{c} represents the convolution matrix of h₂, and h₂^{c}^{^{T}} represents the transpose matrix of the convolution matrix of h₂.

Since the above w₁ and w₂ satisfy the aforementioned formula (4), the signal processing circuit 150, by performing the filtering operation based on w₁ and w₂, can minimize the feedback component in the composite signal y.

It should be noted that some exemplary embodiments of this disclosure do not limit the specific values of w₁ and w₂, and formula (5) and formula (6) are merely one set of possible examples. A person skilled in the art can understand that w₁ and w₂ can also take other values, as long as they are not both zero at the same time and satisfy the aforementioned formula (4).

In some exemplary embodiments, the target constraint may comprise: the degree of attenuation of the signal component in the composite signal y corresponding to the second sound is within a preset range (or, in other words, the degree of attenuation is less than or equal to a preset value). “Minimizing the signal component in the composite signal y corresponding to the first sound under the above target constraint” can be understood as: reducing the signal component in the composite signal y corresponding to the first sound to the greatest extent possible, under the premise of not attenuating, or minimizing the attenuation of, the signal component in the composite signal y corresponding to the second sound. Thus, during the above filtering process, since the signal component in the composite signal y corresponding to the first sound is reduced as much as possible, and the signal component corresponding to the second sound is either not attenuated or only minimally attenuated, the accuracy of the composite signal y obtained based on the above target constraint is relatively high.

Based on the above target constraint, the M sets of target filtering parameters (i.e., w₁ to w_{M}) can be derived based on the first transfer functions h₁ to h_{M} and the second transfer functions d₁ to d_{M}. The following provides an illustration using two possible solving approaches.

For example, the signal processing circuit 150 can obtain the target filtering parameters w₁ to w_{M} in the following manner:

(1) Based on the first transfer functions h₁ to h_{M}, generate a first expression with the goal of minimizing the signal component in the composite signal y corresponding to the first sound. Herein, the first expression treats the first transfer functions h₁ to h_{M} as known quantities and the target filtering parameters w₁ to w_{M} as unknown quantities.

For instance, the first expression can be represented using formula (4). In this case, the meaning of the first expression is: minimizing the transfer function between the first sound x and the composite signal y.

$$min {‖ {\sum }_{n = 1}^{M} ( {h}_{n} * {w}_{n} ) ‖}_{i} \qquad Formula ( 4 )$$

Where ∥⋅∥ᵢ represents the i-norm, and the value of i can be 1, 2, or ∞.

(2) Generate a second expression based on the second transfer functions d₁ to d_{M} and the target constraint. Herein, the second expression treats the second transfer functions d₁ to d_{M} as known quantities and the target filtering parameters w₁ to w_{M} as unknown quantities.

For example, the second expression can be represented using formula (7). In this case, the meaning of the second expression is: the transfer function between the second sound v and the composite signal y is equal to the second transfer function d₁. In other words, the comprehensive pickup effect of the sound sensor module 120 on the second sound (i.e., the signal component in the composite signal y corresponding to the second sound) is equivalent to the pickup effect of a single sound sensor 120-1 on the second sound. A person skilled in the art can understand that formula (7) ensures that the degree of attenuation of the signal component in the composite signal y corresponding to the second sound remains within a preset range.

$${\sum }_{n = 1}^{M} ( {d}_{n} * {w}_{n} ) = {d}_{1} \qquad Formula ( 7 )$$

It should be noted that the above formula (7) is only one possible form of the second expression. In practical applications, the second expression can also take other forms. For example, the content on the right side of the equal sign in formula (7) could be modified to any one of d₂ to d_{M}. Alternatively, for instance, the second expression could also be represented using formula (7-1):

$${\sum }_{n = 1}^{M} ( {\tilde{d}}_{n} * {w}_{n} ) = e \qquad Formula ( 7 - 1 )$$

Herein, in formula (7-1), e represents the unit vector. Formula (7-1) can be regarded as a normalized version of the second transfer functions d₁ to d_{M} in formula (7). Alternatively, by taking one of the M sound sensors (e.g., sound sensor 120-1) as the reference sound sensor, the meaning of d′n can be understood as: the relative transfer function between the target sound source 160 and the nth sound sensor with respect to the reference sound sensor.

(3) Using the second expression (e.g., formula (7) or formula (7-1)) as the constraint condition and the first expression (e.g., formula (4)) as the objective function, solve for the target filtering parameters w₁ to w_{M}.

For example, by using formula (7-1) as the constraint condition and formula (4) as the objective function, the analytical solution obtained is as follows:

$$W = {( {H}^{T} H )}^{- 1} {{\tilde{D}}^{T} ( \tilde{D} {( {H}^{T} H )}^{- 1} {\tilde{D}}^{T} )}^{- 1} e \qquad Formula ( 8 )$$

Where W=[w₁^{T}, w₂^{T}, . . . , w_{M}^{T}]^{T}, H=[h₁^{c}, h₂^{c}, . . . , h_{M}^{c}], \tilde{D}=[\tilde{d}₁^{c}, \tilde{d}₂^{c}, . . . , \tilde{d}_{M}^{c}], represents the transpose matrix of w₁, h₁^{c} represents the convolution matrix of h₁, and \tilde{d}₁^{c} represents the convolution matrix of \tilde{d}₁.

As another example, the signal processing circuit 150 can also obtain the target filtering parameters w₁ to w_{M} in the following manner:

(1) Based on the first transfer functions h₁ to h_{M}, express the transfer function between the first sound x and the composite signal y to generate a third expression. Herein, the third expression treats the first transfer functions h₁ to h_{M} as known quantities and the target filtering parameters w₁ to w_{M} as unknown quantities.

For example, the third expression can be represented using formula (9).

$${\sum }_{n = 1}^{M} ( {h}_{n} * {w}_{n} ) \qquad Formula ( 9 )$$

(2) Generate a fourth expression based on the second transfer functions d₁ to d_{M} and the target constraint. The fourth expression treats the second transfer functions d₁ to d_{M} as known quantities and the target filtering parameters w₁ to w_{M} as unknown quantities.

For example, the fourth expression can be represented using formula (10). In this case, the meaning of the fourth expression is: the difference between the transfer function from the second sound v to the composite signal y and the second transfer function d₁. The smaller this difference, the more it indicates that the comprehensive pickup effect of the sound sensor module 120 on the second sound (i.e., the signal component in the composite signal y corresponding to the second sound) is equivalent to the pickup effect of a single sound sensor 120-1 on the second sound. In this scenario, the degree of attenuation of the signal component in the composite signal y corresponding to the second sound is within a preset range, thus satisfying the target constraint.

$${\sum }_{n = 1}^{M} ( {d}_{n} * {w}_{n} ) - {d}_{1} \qquad Formula ( 10 )$$

It should be noted that the above formula (10) is only one possible form of the fourth expression. In practical applications, the fourth expression can also take other forms. For example, the d₁ in formula (10) could be modified to any one of d₂ to d_{M}. Alternatively, for instance, the fourth expression could also be represented using formula (10-1):

$${\sum }_{n = 1}^{M} ( {\tilde{d}}_{n} * {w}_{n} ) - e \qquad Formula ( 10 - 1 )$$

Herein, in formula (10-1), e represents the unit vector. Formula (10-1) can be regarded as a normalized version of the second transfer functions d₁ to d_{M} in formula (10). Alternatively, by taking one of the M sound sensors (e.g., sound sensor 120-1) as the reference sound sensor, the meaning of d′n can be understood as: the relative transfer function between the target sound source 160 and the nth sound sensor with respect to the reference sound sensor.

(3) Perform a weighted summation of the third expression (e.g., formula (9)) and the fourth expression (e.g., formula (10) or formula (10-1)) to obtain a fifth expression.

For example, set the weight corresponding to formula (9) to 1 and the weight corresponding to formula (10-1) to A, then perform a weighted summation of the i-norm of formula (9) and the i-norm of formula (10-1) to obtain formula (11):

$${‖ {\sum }_{n = 1}^{M} ( {h}_{n} * {w}_{n} ) ‖}_{i} + λ * {‖ ( {\sum }_{n = 1}^{M} ( {\tilde{d}}_{n} * {w}_{n} ) - e ) ‖}_{i} \qquad Formula ( 11 )$$

Where ∥⋅∥ᵢ represents the i-norm, and the value of i can be 1, 2, or ∞.

(4) By minimizing the fifth expression as the objective function, solve to obtain the target filtering parameters w₁ to w_{M}.

In other words, solve the following formula (12) as the objective function to obtain the target filtering parameters w₁ to w_{M}. The target filtering parameters w₁ to w_{M} obtained from the solution can be as shown in formula (13).

$$min \{ ‖ {\sum }_{n = 1}^{M} ( {h}_{n} * {w}_{n} ) {‖}_{i} + λ * {‖ ( {\sum }_{n = 1}^{M} ( {\tilde{d}}_{n} * {w}_{n} ) - e ) ‖}_{i} \} \qquad Formula ( 12 )$$

$$W = {λ ( {H}^{T} H + λ {\tilde{D}}^{T} \tilde{D} )}^{- 1} {\tilde{D}}^{T} e \qquad Formula ( 13 )$$

Where W=[w₁^{T}, w₁^{T}, . . . , w_{M}^{T}]^{T}, H=[h₁^{c}, h₂^{c}, . . . , h_{M}^{c}], \tilde{D}=[\tilde{d}₁^{c}, \tilde{d}₂^{c}, . . . , \tilde{d}_{M}^{c}], w₁^{T} represents the transpose matrix of w₁, h₁^{c} represents the convolution matrix of h₁, and \tilde{d}₁^{c} represents the convolution matrix of \tilde{d}₁.

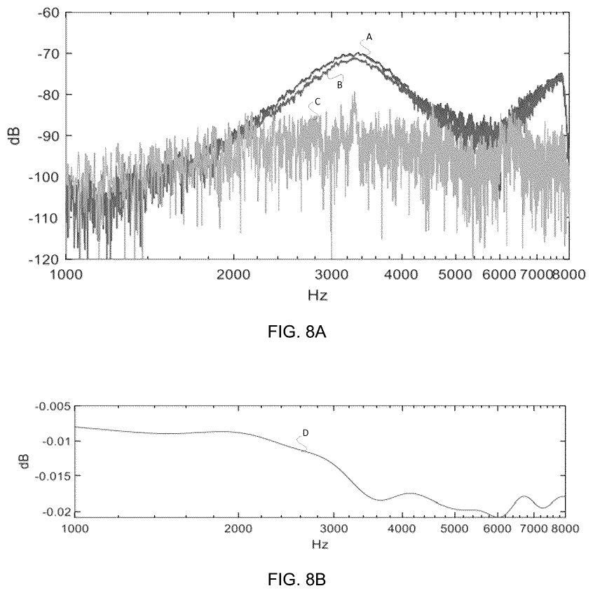

FIG. 8A illustrates a schematic diagram of the cancellation effect of the signal processing scheme shown in FIG. 7 on the sound from the loudspeaker. Referring to FIG. 8A, curve A corresponds to the signal component from loudspeaker 110 in the sound pickup signal y₁ obtained by sound sensor 120-1, curve B corresponds to the signal component from loudspeaker 110 in the sound pickup signal y₂ obtained by sound sensor 120-2, and curve C corresponds to the signal component from loudspeaker 110 in the composite signal y. Comparing curve C with curves A and B, it can be seen that, relative to the sound pickup signal y₁ and sound pickup signal y₂, the signal component from loudspeaker 110 in the composite signal y is significantly reduced, especially in the mid-frequency range (e.g., 2000 Hz to 5000 Hz), where this reduction is more pronounced. This demonstrates that the signal processing method shown in FIG. 7 can effectively reduce the signal component from loudspeaker 110 (i.e., the feedback component) in the composite signal y.

FIG. 8B illustrates a schematic diagram of the attenuation effect of the signal processing scheme shown in FIG. 7 on the sound from the target sound source. Referring to FIG. 8B, curve D shows the attenuation of the signal component from the target sound source 160 in the composite signal y. As can be seen from FIG. 8B, the signal processing method shown in FIG. 7 does not significantly attenuate the signal component from the target sound source 160 in the composite signal y, with the attenuation amount basically within 0.01 dB. This indicates that the signal processing method shown in FIG. 7 can, on one hand, effectively reduce the feedback component in the composite signal y, and on the other hand, avoid or minimally attenuate the signal component from the target sound source 160 in the composite signal y.

Among the methods described earlier for solving the target filtering parameters w₁ to w_{M}, all require the use of the first transfer functions h₁ to h_{M}. It should be noted that the signal processing circuit 150 can obtain the first transfer functions h₁ to h_{M} in various ways. The following provides examples of just two possible methods for illustration.

Method 1: The signal processing circuit 150 can control the loudspeaker 110 to emit a test sound to measure and obtain the first transfer functions h₁ to h_{M}. The specific measurement method can be as follows:

(1) Send a test signal to the loudspeaker 110 to drive the loudspeaker 110 to emit a test sound.

For example, the signal processing circuit 150 can trigger the sending of a test signal to the loudspeaker 110 to drive the loudspeaker 110 to emit a test sound after detecting that the acoustic system 003 has entered a worn state. Alternatively, for example, the signal processing circuit 150 may comprise a Voice Activity Detection (VAD) unit, which can be connected to the sound sensor module 120 and obtain M sound pickup signals from the sound sensor module 120. The VAD unit can determine, based on the M sound pickup signals, whether human voice is present in the current environment and/or assess the signal energy of the loudspeaker 110. If it is determined that no human voice is present in the current environment and/or the signal energy of the loudspeaker 110 is below a preset threshold, the signal processing circuit 150 can send a test signal to the loudspeaker 110 to drive the loudspeaker 110 to emit a test sound. This approach helps avoid interference from other sounds with the test sound.

(2) Obtain the M collected signals picked up by the M sound sensors from the test sound, respectively.

(3) Determine the M first transfer functions based on the test signal and the M collected signals.

For example, taking sound sensor 120-1 as an illustration: a sound sensor 120-1 picks up the test sound and generates a collected signal. Subsequently, the signal processing circuit 150 can determine the first transfer function h₁ between the loudspeaker 110 and the sound sensor 120-1 based on the test signal and the collected signal. A person skilled in the art can understand that the signal processing circuit 150 can use a similar method to determine the first transfer functions h₂ to h_{M}.

The signal processing circuit 150 measures and obtains the first transfer functions h₁ to h_{M} by controlling the loudspeaker 110 to emit a test sound, offering a simple implementation with high application flexibility.

Method 2: When the same acoustic system is worn by different users or by the same user multiple times, it may be in different wearing postures. When the wearing posture of the acoustic system changes, the acoustic transmission path from the loudspeaker 110 to each sound sensor may change accordingly. Thus, it can be seen that the first transfer functions h₁ to h_{M} are related to the current wearing posture of the acoustic system 003. Therefore, the signal processing circuit 150 can determine the first transfer functions h₁ to h_{M} based on the current wearing posture.

Specifically, the signal processing circuit 150 can obtain the first transfer functions h₁ to h_{M} in the following manner:

(1) Determine the current wearing posture corresponding to the acoustic system 003.

Herein, the current wearing posture refers to the position and orientation of the acoustic system 003 while being worn by the user. For example, the acoustic system 003 may predefine several wearing levels, with each level corresponding to a different wearing posture. When wearing the acoustic system, the user can select one of the wearing levels based on their needs. In this case, the signal processing circuit 150 can determine the current wearing posture based on the wearing level selected by the user. Alternatively, for example, the acoustic system 003 may also be equipped with a posture detection device, which can detect the current wearing posture of the acoustic system 003 in real-time or periodically. In this way, the signal processing circuit 150 can be connected to the posture detection device and obtain the current wearing posture from the posture detection device.

(2) Determine the first transfer functions h₁ to h_{M} based on the current wearing posture.

For example, before the acoustic system 003 leaves the factory, the first transfer functions of the acoustic system 003 under different wearing postures can be measured, and the measurement results can be stored in the storage device of the acoustic system 003. For instance, the measurement results can be as shown in Table 1. In this way, when the signal processing circuit 150 needs to obtain the first transfer functions h₁ to h_{M}, it can query the measurement results described in Table 1 based on the current wearing posture, thereby obtaining the first transfer functions h₁ to h_{M} corresponding to the current wearing posture.

TABLE 1

| Wearing posture | |
|---|---|
| First wearing | The first transfer function h₁ |
| posture | between the loudspeaker 110 |
| | and the sound sensor 120-1 |
| | The first transfer function h₂ |
| | between the loudspeaker 110 |
| | and the sound sensor 120-2 |
| | . . . |
| | The first transfer function h_{M} |
| | between the loudspeaker 110 |
| | and the sound sensor 120-M |
| Second wearing | The first transfer function h₁ |
| posture | between the loudspeaker 110 |
| | and the sound sensor 120-1 |
| | The first transfer function h₂ |
| | between the loudspeaker 110 |
| | and the sound sensor 120-2 |
| | . . . |
| | The first transfer function h_{M} |
| | between the loudspeaker 110 |
| | and the sound sensor 120-M |
| . . . | . . . |

The above Method 2 obtains the first transfer functions h₁ to h_{M} corresponding to different wearing postures through pre-measurement, allowing the signal processing circuit 150 to detect the current wearing posture of the acoustic system and determine the first transfer functions h₁ to h_{M} based on the current wearing posture. This approach can improve the efficiency of solving the M sets of target filtering parameters.

It should be noted that the two methods described above can be combined or used collaboratively. For example, when the user initially wears the acoustic system 003, the signal processing circuit 150 can use Method 1 to obtain the first transfer functions h₁ to h_{M}. During prolonged use by the user, the signal processing circuit 150 can periodically use Method 2 every preset time interval to obtain the first transfer functions h₁ to h_{M}. This ensures improved accuracy of the first transfer functions h₁ to h_{M} across different wearing scenarios, thereby enabling the M sets of target filtering parameters to more accurately eliminate feedback components and enhance the effect of feedback sound cancellation. In some of the methods described earlier for solving the target filtering parameters w₁ to w_{M}, the second transfer functions d₁ to d_{M} are required. It should be noted that the signal processing circuit 150 can obtain the second transfer functions d₁ to d_{M} in various ways, and the following provides examples of just two possible methods for illustration.

Method 1: The signal processing circuit 150 can obtain the second transfer functions d₁ to d_{M} from a preset storage space.

For example, before the acoustic system 003 leaves the factory, the second transfer functions d₁ to d_{M} can be measured based on the pickup characteristics of the acoustic system 003 for an external sound source. Taking the second transfer function d₁ as an example, the measurement method may comprise: providing a test signal to the external sound source to drive the external sound source to emit a test sound, obtaining the collected signal generated by the sound sensor 120-1 picking up the test sound, and then determining the second transfer function d₁ between the external sound source and the sound sensor 120-1 based on the test signal and the collected signal. A person skilled in the art can understand that the second transfer functions d₂ to d_{M} can be tested and obtained using a similar method as described above. The second transfer functions d₁ to d_{M} obtained from the above measurements can be stored in the preset storage space. In this way, when the signal processing circuit 150 needs to use the second transfer functions d₁ to d_{M}, it can read them from the preset storage space.

The above method obtains the second transfer functions d₁ to d_{M} through pre-measurement and stores them in the preset storage space, allowing the signal processing circuit 150 to directly read the second transfer functions d₁ to d_{M} from the preset storage space when solving the M sets of target filtering parameters. This can improve the efficiency of solving the M sets of target filtering parameters.

Method 2: Since the target sound source 160 can be considered a far-field sound source, the sound waves from a far-field source approximate plane waves, meaning the amplitude of the sound waves decreases minimally with propagation. Therefore, the sound waves from the target sound source 160 picked up by different sound sensors can be regarded as having only phase differences. Thus, for any two sound sensors, the second transfer functions from the target sound source 160 to these two sensors differ only by a certain time delay, and this time delay is related to the distance between the two sound sensors. Consequently, the signal processing circuit 150 can hypothesize the second transfer functions d₁ to d_{M} based on the distances between different sound sensors.

Specifically, the signal processing circuit 150 can set the i-th second transfer function as a preset function, where i is an integer less than or equal to M; then, based on the i-th second transfer function and the distance between the j-th sound sensor and the i-th sound sensor, determine the j-th second transfer function, where j is an integer less than or equal to M, and j is different from i.

For example, assume M=3, and set d₁ as the unit impulse function δ(n). d₂ can be obtained as follows: based on the distance between sound sensor 120-2 and sound sensor 120-1, determine the time delay information of d₂ relative to d₁, and then determine d₂ based on this time delay information and d₁. Similarly, d₃ can be obtained as follows: based on the distance between sound sensor 120-3 and sound sensor 120-1, determine the time delay information of d₃ relative to d₁, and then determine d₃ based on this time delay information and d₁. A person skilled in the art can understand that when setting d₁, the signal processing circuit can also set d₁ to other forms of transfer functions; the unit impulse function δ(n) mentioned above is merely one possible example.

The above method can hypothesize the second transfer functions d₁ to d_{M} based on the distances between different sound sensors, eliminating the need to pre-measure the second transfer functions d₁ to d_{M}, thus offering high application flexibility.

S30: Perform a target operation on the composite signal.

After obtaining the composite signal y, the signal processing circuit 150 can perform a target operation on the composite signal y based on the requirements of the application scenario.

For example, in some exemplary embodiments, continuing to refer to FIG. 7, the signal processing circuit 150 may also be connected to the loudspeaker 110. In this case, the target operation may comprise a gain amplification operation. That is, after obtaining the composite signal y, the signal processing circuit 150 performs gain amplification on the composite signal y and sends the gain-amplified signal as a driving signal to the loudspeaker 110 to drive the loudspeaker 110 to produce sound. The above scheme can be applied to the howling suppression scenario shown in FIG. 1. It should be understood that, since the composite signal y has a reduced signal component from the loudspeaker 110 (or in other words, a reduced feedback component), it disrupts the conditions for the sound emitted by the loudspeaker 110 to generate howling in the closed-loop circuit shown in FIG. 1, thereby achieving the effect of suppressing howling.

In some exemplary embodiments, the aforementioned gain amplification operation can be implemented by the processor 220 in the signal processing circuit 150, meaning that the processor 220 executes a set of instructions and performs the gain amplification operation according to the instructions. In some exemplary embodiments, the signal processing circuit 150 may comprise a gain amplification circuit, and the aforementioned gain amplification operation can be realized through the gain amplification circuit.

In some exemplary embodiments, the loudspeaker 110, the sound sensor module 120, and the signal processing circuit 150 can be integrated into a first acoustic device, which is communicatively connected to a second acoustic device. In this case, the target operation may comprise: sending the composite signal y to the second acoustic device to reduce echo in the second acoustic device. The above scheme can be applied to the echo cancellation scenario shown in FIG. 2. For example, the first acoustic device can be a local-end device, and the second acoustic device can be a remote-end device. Since the composite signal y has a reduced signal component from the loudspeaker 110 (or in other words, a reduced feedback component), it effectively reduces the sound from the second acoustic device. Therefore, when the second acoustic device receives and plays the composite signal y, the user on the second acoustic device side (i.e., the remote user) will not hear or will hear less echo, thereby achieving the effect of echo cancellation.

In summary, the signal processing method and acoustic system provided by some exemplary embodiments of this disclosure operate as follows: the M sound sensors in the sound sensor module 120 collect ambient sound during operation and generate M sound pickup signals. The signal processing circuit 150 can perform a filtering operation on the M sound pickup signals based on M sets of target filtering parameters to obtain M filtered signals, then perform a synthesis operation on the M filtered signals to obtain a composite signal, and subsequently execute a target operation on the composite signal. Since the M sets of target filtering parameters are configured to minimize the signal component from the loudspeaker in the composite signal under a target constraint, the aforementioned filtering operation can reduce or eliminate feedback sound (i.e., sound from the loudspeaker) in the acoustic system, thereby preventing issues such as howling or echo in the acoustic system.

Another aspect of this disclosure provides a non-transitory storage medium storing at least one set of executable instructions for signal processing. When the executable instructions are executed by a processor, the executable instructions direct the processor to perform the steps of the signal processing method P100 described in this disclosure. In some possible implementations, various aspects of this disclosure may also be embodied in the form of a program product that comprises program code. When the program product runs on an acoustic system, the program code is used to cause the acoustic system to execute the steps of the signal processing method P100 described in this disclosure. The program product for implementing the above method may employ a portable compact disc read-only memory (CD-ROM) that comprises program code and can run on an acoustic system. However, the program product of this disclosure is not limited to this. In this disclosure, the readable storage medium can be any tangible medium that contains or stores a program, which can be used by or in combination with an instruction execution system. The program product may employ any combination of one or more readable media. The readable medium may be a readable signal medium or a readable storage medium. The readable storage medium may comprise, but is not limited to, an electrical, magnetic, optical, electromagnetic, infrared, or semiconductor system, apparatus, or device, or any combination thereof. More specific examples of readable storage media comprise: an electrical connection with one or more wires, a portable disk, a hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination of the above. The computer-readable storage medium may comprise a data signal propagated in baseband or as part of a carrier wave, carrying readable program code. Such a propagated data signal may take various forms, including but not limited to electromagnetic signals, optical signals, or any suitable combination thereof. The readable storage medium may also be any readable medium other than a readable storage medium that can transmit, propagate, or transport a program for use by or in combination with an instruction execution system, apparatus, or device. The program code contained on the readable storage medium may be transmitted using any suitable medium, including but not limited to wireless, wired, optical cable, RF, etc., or any suitable combination thereof. The program code for performing the operations of this disclosure may be written in any combination of one or more programming languages, including object-oriented programming languages such as Java, C++, etc., as well as conventional procedural programming languages such as the “C” language or similar programming languages. The program code may be executed entirely on the acoustic system, partially on the acoustic system, as a standalone software package, partially on the acoustic system and partially on a remote computing device, or entirely on a remote computing device.

The above description pertains to specific embodiments of the present disclosure. Other embodiments are within the scope of the appended claims. In some cases, the actions or steps described in the claims can be performed in a sequence different from the one in the embodiments and still achieve the desired result. Additionally, the processes depicted in the drawings do not necessarily require a specific order or continuous sequence to achieve the desired outcome. In certain embodiments, multitasking and parallel processing are also possible or may be beneficial.

In summary, after reading this detailed disclosure, a person skilled in the art can understand that the aforementioned detailed disclosure is presented only by way of example and is not intended to be limiting. Although not explicitly stated herein, a person skilled in the art will appreciate that the disclosure encompasses various reasonable alterations, improvements, and modifications to the embodiments. These alterations, improvements, and modifications are intended to be within the spirit and scope of the exemplary embodiments presented in this disclosure.

In addition, certain terms in this disclosure have been used to describe the embodiments of the disclosure. For example, the terms “one embodiment,” “embodiment,” and/or “some exemplary embodiments” mean that specific features, structures, or characteristics described in connection with that embodiment may be comprised in at least one embodiment of the disclosure. Therefore, it should be emphasized and understood that references to “embodiment,” “one embodiment,” or “alternative embodiment” in various parts of this disclosure do not necessarily refer to the same embodiment. Additionally, specific features, structures, or characteristics may be appropriately combined in one or more embodiments of the disclosure.

It should be understood that in the foregoing description of the embodiments of the disclosure, in order to aid in understanding a feature and simplify the presentation, various features are combined in a single embodiment, drawing, or description. However, this does not mean that the combination of these features is required. A person skilled in the art, upon reading this disclosure, could very well consider part of the equipment marked as a separate embodiment. In other words, the embodiments in this disclosure can also be understood as the integration of multiple sub-embodiments. And each sub-embodiment is valid even when it comprises fewer features than a single full embodiment disclosed above.

Each patent, patent application, publication of a patent application, and other materials, such as articles, books, disclosures, publications, documents, articles, etc., cited herein, except for any historical prosecution documents to which it relates, which may be inconsistent with or any identities that conflict, or any identities that may have a restrictive effect on the broadest scope of the claims, are hereby incorporated by reference for all purposes now or hereafter associated with this document. Furthermore, in the event of any inconsistency or conflict between the description, definition, and/or use of a term associated with any contained material, the term used in this document shall prevail.

Finally, it should be understood that the embodiments of the application disclosed herein are illustrative of the principles of the embodiments of this disclosure. Other modified embodiments are also within the scope of this disclosure. Therefore, the embodiments disclosed in this disclosure are merely examples and not limitations. A person skilled in the art can adopt alternative configurations based on the embodiments in this disclosure to implement the application in this disclosure. Thus, the embodiments of this disclosure are not limited to the embodiments described in the application in precise detail.

What is claimed is:

1. An acoustic system, comprising:
a speaker, configured to receives a driving signal and converts the driving signal into a first sound during operation;
a sound sensor module, wherein the sound sensor module comprises M sound sensors and is configured to pick up an ambient sound and generate M sound pickup signals, wherein the ambient sound comprises the first sound and a second sound from a target sound source, and M is an integer greater than 1; and
a signal processing circuit, connected to the sound sensor module, wherein during operation, the signal processing circuit is configured to perform:
obtaining M sound pickup signals,
performing a filtering operation on the M sound pickup signals based on M sets of target filtering parameters to obtain M filtered signals, and performing a synthesis operation on the M filtered signals to obtain a composite signal, wherein the M sets of target filtering parameters are configured to minimize a signal component corresponding to the first sound in the composite signal under a target constraint, and
performing a target operation on the composite signal.

2. The acoustic system according to claim 1, wherein the target constraint comprises: a degree of attenuation of a signal component corresponding to the second sound in the composite signal is within a preset range.

3. The acoustic system according to claim 2, wherein the M sets of target filtering parameters are obtained based on M first transfer functions and M second transfer functions, wherein
an nth first transfer function is a transfer function between the speaker and an nth sound sensor,
an nth second transfer function is a transfer function between the target sound source and the nth sound sensor, and
n is an integer less than or equal to M.

4. The acoustic system according to claim 3, wherein the M sets of target filtering parameters are obtained by:
generating, based on the M first transfer functions, a first expression with a goal of minimizing the signal component corresponding to the first sound in the composite signal, wherein the first expression takes the M sets of target filtering parameters as unknowns;
generating, based on the M second transfer functions and the target constraint, a second expression, wherein the second expression takes the M sets of target filtering parameters as unknowns; and
using the second expression as a constraint condition and the first expression as an objective function for solving to obtain the M sets of target filtering parameters.

5. The acoustic system according to claim 3, wherein the M sets of target filtering parameters are obtained by:
expressing, based on the M first transfer functions, a transfer function between the first sound to the composite signal to generate a third expression, wherein the third expression takes the M sets of target filtering parameters as unknowns;
generating, based on the M second transfer functions and the target constraint, a fourth expression, wherein the fourth expression takes the M sets of target filtering parameters as unknowns;
performing a weighted summation of the third expression and the fourth expression to obtain a fifth expression; and
using minimizing the fifth expression as an objective function for solving to obtain the M sets of target filtering parameters.

6. The acoustic system according to claim 3, wherein the M first transfer functions are obtained by:
determining a current wearing posture corresponding to the acoustic system; and
determining the M first transfer functions based on the current wearing posture.

7. The acoustic system according to claim 3, wherein the M first transfer functions are obtained by:
sending a test signal to the speaker to drive the speaker to emit a test sound;
obtaining M collected signals picked up by the M sound sensors from the test sound, respectively; and
determining the M first transfer functions based on the test signal and the M collected signals.

8. The acoustic system according to claim 3, wherein the M second transfer functions are obtained by:
obtaining the M second transfer functions from a preset storage space.

9. The acoustic system according to claim 3, wherein the M second transfer functions are obtained by:
setting an ith second transfer function as a preset function, wherein i is an integer less than or equal to M; and
determining a jth second transfer function based on the ith second transfer function and a distance between a jth sound sensor and an ith sound sensor, wherein j is an integer less than or equal to M, and j is different from i.

10. The acoustic system according to claim 1, wherein the target constraint comprises: the M sets of target filtering parameters are not simultaneously zero; and
the M sets of target filtering parameters are obtained based on M first transfer functions, wherein an nth first transfer function is a transfer function between the speaker and the nth sound sensor, and n is an integer less than or equal to M.

11. The acoustic system according to claim 10, wherein the M sets of target filtering parameters comprise K sets of first filtering parameters and M-K sets of second filtering parameters, wherein K is an integer greater than or equal to 1; and
the M sets of target filtering parameters are obtained by:
setting the K sets of first filtering parameters to preset non-zero values, and
determining the M-K sets of second filtering parameters based on the M first transfer functions and the K sets of first filtering parameters.

12. The acoustic system according to claim 1, wherein to perform the target operation on the composite signal, the signal processing circuit performs gain amplification on the composite signal, and sending a gain-amplified signal as a driving signal to the speaker to drive the speaker to produce a sound.

13. The acoustic system according to claim 1, wherein the speaker and the sound sensor module are arranged on a first acoustic device, and the first acoustic device is in communication with a second acoustic device; and
to perform the target operation on the composite signal, the signal processing circuit sends the composite signal to the second acoustic device to reduce an echo of the second acoustic device.

14. The acoustic system according to claim 1, wherein the signal processing circuit comprises:
at least one storage medium, storing at least one instruction set for signal processing; and
at least one processor, in communication with the sound sensor module and the at least one storage medium, wherein, when the acoustic system is operating, the at least one processor reads the at least one instruction set and execute, according to the at least one instruction set, the filtering operation and the target operation.

15. The acoustic system according to claim 1, wherein the acoustic system is any one of a hearing aid system, a sound amplification system, a headphone system, a telephone system, or a conference system.

16. The acoustic system according to claim 1, wherein the acoustic system is a hearing aid system and further comprises a housing, and the speaker module, the sound sensor module and the signal processing circuit are disposed within the housing, wherein
when the acoustic system is worn on a user's head, a sound output end of the speaker module faces the user's head, and a sound pickup end of at least one sound sensor in the sound sensor module is located on a side of the housing away from the user's head.

17. A signal processing method, comprising:
obtaining M sound pickup signals, wherein the M sound pickup signals are respectively obtained by M sound sensors in a sound sensor module of an acoustic system collecting an ambient sound during operation, the ambient sound comprises a first sound and a second sound, the first sound is a sound from a speaker in the acoustic system, and the second sound is a sound from a target sound source, wherein M is an integer greater than 1;
performing a filtering operation on the M sound pickup signals based on M sets of target filtering parameters to obtain M filtered signals, and performing a synthesis operation on the M filtered signals to obtain a composite signal, wherein the M sets of target filtering parameters are configured to minimize a signal component corresponding to the first sound in the composite signal under a target constraint; and
performing a target operation on the composite signal.

18. The method according to claim 17, wherein the target constraint comprises: a degree of attenuation of a signal component corresponding to the second sound in the composite signal is within a preset range.

19. The method according to claim 18, wherein the M sets of target filtering parameters are obtained based on M first transfer functions and M second transfer functions, wherein
an nth first transfer function is a transfer function between the speaker and an nth sound sensor,
an nth second transfer function is a transfer function between the target sound source and the nth sound sensor, and
n is an integer less than or equal to M.

20. The method according to claim 19, wherein the M sets of target filtering parameters are obtained by:
generating, based on the M first transfer functions, a first expression with a goal of minimizing the signal component corresponding to the first sound in the composite signal, wherein the first expression takes the M sets of target filtering parameters as unknowns, generating, based on the M second transfer functions and the target constraint, a second expression, wherein the second expression takes the M sets of target filtering parameters as unknowns, and using the second expression as a constraint condition and the first expression as an objective function for solving to obtain the M sets of target filtering parameters; or
expressing, based on the M first transfer functions, a transfer function between the first sound to the composite signal to generate a third expression, wherein the third expression takes the M sets of target filtering parameters as unknowns, generating, based on the M second transfer functions and the target constraint, a fourth expression, wherein the fourth expression takes the M sets of target filtering parameters as unknowns; performing a weighted summation of the third expression and the fourth expression to obtain a fifth expression, and using minimizing the fifth expression as an objective function for solving to obtain the M sets of target filtering parameters.
